(19) United States
(12) Patent Application Publication
(10) Pub. No.: US 2007/0132636 A1
(43) Pub. Date: Jun. 14, 2007

(54) Multi-receiver satellite positioning system method and system for improved performance

(75) Inventors: Jason T. Young, Palm City, FL (US); Brian E. Bucknor, Miramar, FL (US); Roberto Gautier, Davie, FL (US); Glen S. Uehara, Gilbert, AZ (US); Keith M. Klug, Mesa, AZ (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/300,072

(22) Filed: Dec. 14, 2005

(51) Int. Cl. G01S 5/14

(52) U.S. Cl. 342/357.15

(57) ABSTRACT

A multi-receiver satellite positioning system (SPS) wireless device (101) and system (100) or method (200) can include a plurality of SPS receivers co-located with each other, and a processor (114). The processor can be coupled to a first SPS receiver (102) and at least a second SPS receiver (104). The processor can be programmed to select (202) a measurement from the first SPS receiver or from at least the second SPS receiver having a desired characteristic, and use (212) the calculated measurement selected for having the desired characteristic for a predetermined application. For example, the processor can select the measurement by comparing (206) a possible error in position (EPE) reported by the first SPS receiver with a possible error in position reported by the at least second SPS receiver and selecting the measurement with the least amount of EPE when accuracy is a desired characteristic.

### FIELD OF THE INVENTION

This invention relates generally to Satellite Positioning System (SPS) devices, and more particularly to a method and system for using SPS receivers to improve performance.

### BACKGROUND OF THE INVENTION

An SPS system such as the Global Positioning System (GPS) has 24 satellites orbiting the earth (21 operational and 3 spares). These satellites are arranged into 6 high orbit planes at a height of 10,898 nautical miles or 20,200 kilometers with each orbit containing three or four satellites. The orbital planes form a 55 degree angle with the equator with orbital periods for each satellite of approximately 12 hours.

With no obstruction, there are typically 8-12 satellites visible at any one time from anywhere on earth. Each satellite contains a highly accurate (Rubidium atomic) clock. Taken together, several GPS satellites can represent an extremely accurate time standard available for synchronization at any point on the earth. It is this accurate timing that leads to an application of the GPS satellites separate from their function for navigation. The world's cellular and fiber communications use the time information derived from the GPS satellites for clock synchronization. Each satellite transmits a spread spectrum signal containing a BPSK (Bi-Phase Switched keyed) signal in which 1's and 0's are represented by reversal of the phase of the carrier. This message is transmitted at the L1 frequency 1575.42 MHz at a “chipping rate” of 50 bits per second. The message repeats every 30 minutes and is called the C/A signal (Coarse Acquisition signal). This message contains two important elements, the almanac and the ephemeris. The Almanac contains information about all the satellites in the constellation. This information is regularly updated from ground stations monitoring the system but almanac data remains useful for around one year. The Ephemeris contains short-lived information about the constellation and the particular satellite sending it. The particular satellite's information is updated from the GPS ground stations every four hours. Its validity in calculating position deteriorates gradually over this period as satellites rise and fall above the horizon. There are also other encrypted signals: the P code and Y code that are used for military applications transmitted at frequencies L1 & L2.

GPS signals are typically weak and require a radio frequency (RF) front end that has a low noise figure and very high gain. To derive a position solution including altitude, the GPS receiver must acquire and receive a full set of ephemeris from 4 or more satellites to compute a solution. The transfer of ephemeris from the GPS satellites is relatively slow (noted above as 50 bps), so alternative transmissions sources (such as a cell phone networks) have been used to send ephemeris and frequency uncertainty information to enable a GPS handset to compute a solution more expeditiously.

GPS is an example of a satellite position system (SPS) that may be utilized by a wireless device in combination with an appropriate GPS receiver to pinpoint the location of the wireless device on earth. The array of GPS satellites transmits highly accurate, time coded information that permits a receiver to calculate its exact location in terms of latitude and longitude on earth as well as the altitude above sea level (when 4 or more GPS satellites are acquired). The GPS system is designed to provide a base navigation system with accuracy to within 100 meters for non-military use and greater precision for the military.

As mentioned above, each of the orbiting satellites contains accurate clocks and more particularly four highly accurate atomic clocks. These provide precision timing pulses used to generate a unique binary code (also known as a pseudo random or pseudo noise “PN” code) that is transmitted to earth. The PN code identifies the specific satellite in the constellation. The satellite also transmits a set of digitally coded ephemeris data that completely defines the precise orbit of the satellite. The ephemeris data indicates where the satellite is at any given time, and its location may be specified in terms of a satellite ground track in precise latitude and longitude measurements. The information in the ephemeris data is coded and transmitted from the satellite providing an accurate indication of the exact position of the satellite above the earth at any given time. A ground control station updates the ephemeris data of the satellite once per day to ensure accuracy.

A GPS receiver configured in a wireless device is designed to pick up signals from three, four, or more satellites simultaneously. The GPS receiver decodes the information and, utilizing the time and ephemeris data, calculates the approximate position of the wireless device. The GPS receiver contains a floating-point processor that performs the necessary calculations and may output a decimal display of latitude and longitude as well as altitude on the handset. Readings from three satellites are necessary for latitude and longitude information. A fourth satellite reading is required in order to compute altitude.

Techniques that use cellular based location aiding information, however, still require a cellular network connection that may not necessarily be available within all of the areas within the footprint of the “viewable” GPS satellites. Thus, time to first fix (TTFF) times are usually relatively long.

Even with some additional information, TTFF times may be over thirty seconds because the ephemeris data must be acquired from the SPS system itself, and the SPS receiver typically needs a strong signal to acquire the ephemeris data reliably. These characteristics of a SPS system typically impact the reliability of position availability and power consumption in wireless devices. Typically, the accuracy of location-based solutions may vary from 150 meters to 300 meters in these types of environments. As a result, locating a wireless device in a 300 meter radius zone is unlikely unless there are other methods to help narrow the search.

Attempts at solving this problem have included utilizing pseudolites (such as base stations in a cellular telephone network) in combination with SPS, such as GPS, to determine the location of the wireless device. Other systems just use dual GPS to provide redundancy but do not necessarily share information to improve the performance of the other corresponding receiver.

### SUMMARY OF THE INVENTION

Embodiments in accordance with the present invention can utilize information received from a secondary SPS receiver to aid in a similar manner as cellular phone networks and phone receivers have done or to alternatively provide an improved option among selected processed signals. Any SPS capable device such as a GPS receiver (and not necessarily limited to a GPS enabled cell phone) can use information from a secondary SPS receiver.

In a first embodiment of the present invention, a multi-receiver satellite positioning system (SPS) radio can include a plurality of SPS receivers co-located with each other, and a processor coupled to a first SPS receiver and at least a second SPS receiver. The processor can be programmed to select a measurement from the first SPS receiver or from at least the second SPS receiver having a desired characteristic, and use the measurement selected for a predetermined application. The processor can select the measurement by comparing a possible error in position (EPE) reported by the first SPS receiver with a possible error in position reported by the at least second SPS receiver and selecting the measurement with the least amount of EPE. The processor can be further programmed to use for Location Based Services (LBS) a first position fix obtained among the plurality of SPS receivers. In another variation, the processor can be programmed to use for initial Location Based Services (LBS) processing a first position fix obtained among the plurality of SPS receivers and then subsequently use the measurement with the least amount of EPE for an LBS application.

The desired characteristic can be a higher average signal strength from a plurality of SPS satellites or a larger number of satellites used in a positioning calculation or a higher average signal strength from a plurality of SPS satellites and a larger number of satellites used in a positioning calculation. Note, a position calculation can be done using the first SPS receiver concurrently with a position calculation using at least the second SPS receiver. In one alternative, the radio can comprise a single antenna coupled to the plurality SPS receivers. In another alternative, the radio can further include a first antenna coupled to the first SPS receiver and a second antenna coupled to at least the second SPS receiver. The desired characteristic can be a measurement providing better navigation performance than acquisition performance or alternatively a measurement providing better acquisition performance than navigation performance. The processor can also be programmed to share ephemeris data from a first reporting SPS receiver among the plurality of SPS receivers with at least a second SPS receiver in order to enable the second SPS receiver to achieve a faster time to fix. The processor can also be programmed to share almanac data from a first SPS receiver among the plurality of SPS receivers with at least a second SPS receiver

In a second embodiment, a multimode cellular phone can include a first mode cellular transceiver having an first SPS receiver associated thereto, at least a second mode cellular transceiver having at least a second SPS receiver associated thereto, and a processor coupled to the first SPS receiver and at least the second SPS receiver. The processor can be programmed to select a measurement from the first SPS receiver or from at least the second SPS receiver having a desired characteristic and use the measurement selected.

In a third embodiment, a method of improving position accuracy can include the steps of receiving positional assistance information from a plurality of satellite position system (SPS) satellites at a plurality of co-located SPS receivers, selecting among calculated measurements from each of the plurality of co-located SPS receivers based on a desired characteristic, and using a selected calculated measurement having the desired characteristic for a predetermined application. Selecting can be done by comparing a possible error in position (EPE) reported by a first SPS receiver with a possible error in position reported by at least second SPS receiver and selecting the measurement with the least amount of EPE for the predetermined application. Selecting can also be done by selecting among calculated measurements from each of the plurality of co-located SPS receivers based on a higher average signal strength from the plurality of SPS satellites and a larger number of SPS satellites used in a positioning calculation. Selecting can also be done by selecting among calculated measurements from each of the plurality of co-located SPS receivers based on a desired navigation performance or a desired acquisition performance. The method can also include the steps of sharing ephemeris data or almanac data from a first SPS receiver among the plurality of SPS receivers with at least a second SPS receiver.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a positioning system using a plurality of SPS receivers in accordance with an embodiment of the present invention.

FIG. 2 is a flow chart illustrating a method of improving position accuracy in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

The positional aiding that can be received from a cell phone requires that a user be registered to a network and can load network traffic. If the user is not on a network, an SPS receiver such as a GPS receiver reverts to a very slow autonomous mode. Note, all mobile phones today have only one GPS receiver. Some dual mode phones in the near future may include two independent GPS receivers to meet E-911 requirements for both modes. Embodiments herein can utilize information from both GPS receivers to improve GPS position accuracy or to obtain a quicker TTFF.

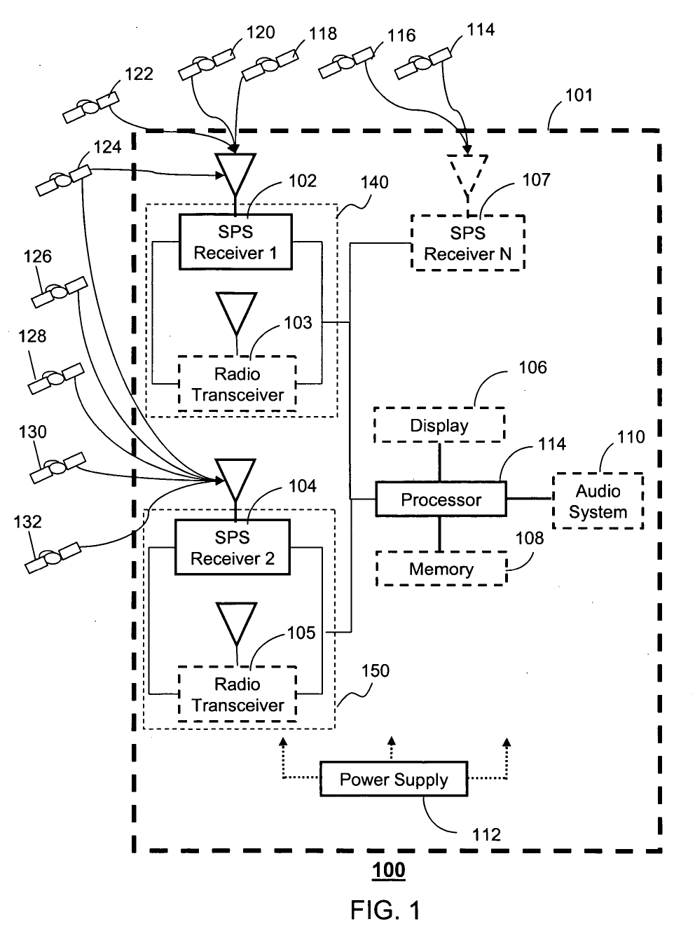

Referring to FIG. 1, a wireless device 101 such a multimode radio in a communication system 100 can use a first SPS receiver 102, a second SPS receiver and optionally additional SPS receiver(s) 107 to improve accuracy and speed in obtaining calculated positional information. Although the SPS receivers can stand alone (as shown with SPS receiver 107), the SPS receivers can also be part of a combination receiver having both cellular and GPS technologies. For example, the first SPS receiver 102 can be part of a combination CDMA GPS receiver 140 (having a separate cellular transceiver 103) to obtain position fixes for location based services (LBS). When a fix is obtained, a possible error in position (EPE) can also reported. The second SPS receiver 104 can be part of a second combination GPS and cellular-type receiver 150 (having a separate cellular transceiver 105 such an iDEN (or other cellular) receiver which can be configured to run simultaneously and also report a position and an error. The first position reported by any of the SPS receivers (102, 104 or 107) can be used for initial LBS processing. When a second SPS receiver reports a position, the errors can be compared and the position with the smaller error can be used for the LBS application. An additional embodiment could include the use of the reported position that was calculated with the higher average GPS signal strength and number of satellites. It is known that the accuracy of the GPS position is proportional to the signal strength received from the satellites and the number of satellites used in the position calculation. As illustrated, the first satellite “sees” 4 satellites (118, 120, 122, and 124), the second SPS receiver 104 “sees” 5 satellites (124, 126, 128, 130 and 132), and SPS receiver 107 only sees two satellites (114 and 116). Assuming that SPS receiver 104 receives a signal with a higher average GPS signal strength than other SPS receivers, then the location information from receiver 104 can be selected if greater accuracy is desired.

Note, the receivers herein can share a single antenna or use multiple antennas in various configurations that either are used independently or shared. Since the receivers can be configured to operate on two separate RF paths, and possibly have two separate antennas, it is perceivable that based on the wireless device's orientation that one path might be superior to the other. Another embodiment can include the choice of the GPS engine that best performs or demonstrates a particular characteristic. For example, a wireless device can select a GPS receiver or engine that has or provides better navigation dynamics. Navigation from a GPS receiver is sometimes degraded as a trade off for acquisition performance (or TTFF speed). For a better navigation performance, the selection can select the SPS or GPS engine or receiver performs best in motion to provide dynamic position, velocity, and heading information. One permutation of this idea is to use the first reporting system's ephemeris data and approximate position to supply the second system to enable a faster fix by the second system. An additional embodiment could include the sharing of the GPS almanac between the receivers. The SPS receiver with the most recent almanac will either pass it on to the second receiver or be set as a higher priority for off network autonomous acquisitions.

Fortunately, in a system 100 as illustrated in FIG. 1, a cellular phone and its network is optional. Instead, the system 100 can use a plurality of SPS satellites 114-132 and a plurality of SPS satellite receivers 102, 104, and 107 to assist with positional assistance information to enable an the system 100 to make a quicker approximate location determination or to make a more accurate approximate location determination or both. Since one SPS receiver might “see” stronger signals than another SPS satellite or one SPS receiver might be optimized for navigation as opposed to accuracy, the system 100 can use all the received SPS signals at the plurality of SPS receivers to improve overall performance. The signal strengths measured by different (even co-located) GPS receivers can vary and can correspondingly improve or degrade acquisition speed. Bandwidth on the secondary satellite system is likely to be greater as well.

As noted above, the SPS receiver 102 and the SPS receiver 104 can be part of a wireless device 101 such as a lap top computer or a cellular phone or any other electronic device. The electronic device can further include a display 106 for conveying images to a user of the device, a memory 108 including one or more storage elements (e.g., Static Random Access Memory, Dynamic RAM, Read Only Memory, etc.), an optional audio system 110 for conveying audible signals (e.g., voice messages, music, etc.) to the user of the device, a conventional power supply 112 for powering the components of the device, and a processor 114 comprising one or more conventional microprocessors and/or digital signal processors (DSPs) for controlling operations of the foregoing components.

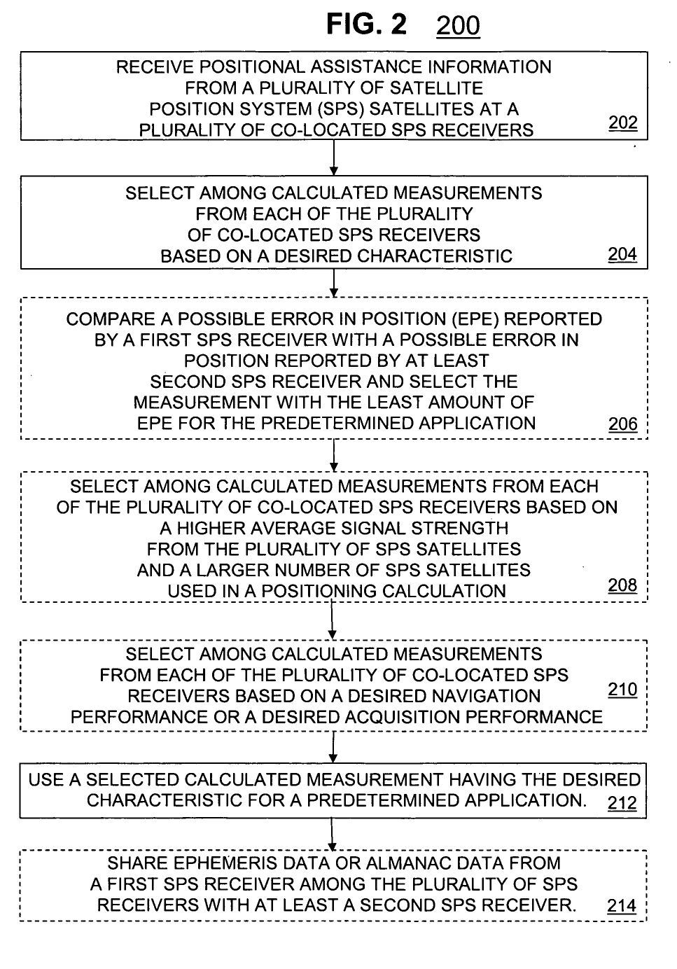

Operationally, the system 100 can operate in accordance a method 200 of improving position accuracy as illustrated in the flow chart of FIG. 2. The method 200 can include the step 202 of receiving positional assistance information from a plurality of satellite position system (SPS) satellites at a plurality of co-located SPS receivers and selecting among calculated measurements from each of the plurality of co-located SPS receivers based on a desired characteristic at step 204. Selecting can be optionally done at step 206 by comparing a possible error in position (EPE) reported by a first SPS receiver with a possible error in position reported by at least second SPS receiver and selecting the measurement with the least amount of EPE for the predetermined application. Selecting can also be optionally done at step 208 by selecting among calculated measurements from each of the plurality of co-located SPS receivers based on a higher average signal strength from the plurality of SPS satellites and a larger number of SPS satellites used in a positioning calculation. At step 210, selecting can also be done by selecting among calculated measurements from each of the plurality of co-located SPS receivers based on a desired navigation performance or a desired acquisition performance. The method 200 can use a selected calculated measurement having the desired characteristic for a predetermined application at step 210. Use of the selected measurement can be for display or other presentation of information or for mere calculation of positional information. The method 200 can also include the step 212 of sharing ephemeris data or almanac data from a first SPS receiver among the plurality of SPS receivers with at least a second SPS receiver.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A multi-receiver satellite positioning system (SPS) radio, comprising:
a plurality of SPS receivers co-located with each other;
a processor coupled to a first SPS receiver and at least a second SPS receiver, wherein the processor is programmed to:
select a measurement from the first SPS receiver or from at least the second SPS receiver having a desired characteristic; and
use the measurement selected for a predetermined application.

2. The radio of claim 1, wherein the processor selects the measurement by comparing a possible error in position (EPE) reported by the first SPS receiver with a possible error in position reported by the at least second SPS receiver and selecting the measurement with the least amount of EPE.

3. The radio of claim 1, wherein the processor is further programmed to use for Location Based Services (LBS) a first position fix obtained among the plurality of SPS receivers.

4. The radio of claim 2, wherein the processor is further programmed to use for initial Location Based Services (LBS) processing a first position fix obtained among the plurality of SPS receivers and then subsequently use the measurement with the least amount of EPE for an LBS application.

5. The radio of claim 1, wherein the desired characteristic is a higher average signal strength from a plurality of SPS satellites.

6. The radio of claim 1, wherein the desired characteristic is a larger number of satellites used in a positioning calculation.

7. The radio of claim 1, wherein the desired characteristic is a higher average signal strength from a plurality of SPS satellites and a larger number of satellites used in a positioning calculation.

8. The radio of claim 1, wherein the processor is programmed to calculate a position using the first SPS receiver concurrently with a position using at least the second SPS receiver.

9. The radio of claim 1, wherein the radio further comprises a single antenna coupled to the plurality SPS receivers.

10. The radio of claim 1, wherein the radio further comprises a first antenna coupled to the first SPS receiver and a second antenna coupled to at least the second SPS receiver.

11. The radio of claim 1, wherein the desired characteristic is a measurement providing better navigation performance than acquisition performance.

12. The radio of claim 1, wherein the desired characteristic is a measurement providing better acquisition performance than navigation performance.

13. The radio of claim 1, wherein the processor is further programmed to share ephemeris data from a first reporting SPS receiver among the plurality of SPS receivers with at least a second SPS receiver in order to enable the second SPS receiver to achieve a faster time to fix.

14. The radio of claim 1, wherein the processor is further programmed to share almanac data from a first reporting SPS receiver among the plurality of SPS receivers with at least a second SPS receiver.

15. A multimode cellular phone, comprising:
a first mode cellular transceiver having an first SPS receiver associated thereto;
at least a second mode cellular transceiver having at least a second SPS receiver associated thereto;
a processor coupled to the first SPS receiver and at least the second SPS receiver, wherein the processor is programmed to:
select a measurement from the first SPS receiver or from at least the second SPS receiver having a desired characteristic; and
use the measurement selected.

16. A method of improving position accuracy, comprising the steps of:
receiving positional assistance information from a plurality of satellite position system (SPS) satellites at a plurality of co-located SPS receivers;
selecting among calculated measurements from each of the plurality of co-located SPS receivers based on a desired characteristic; and
using a selected calculated measurement having the desired characteristic for a predetermined application.

17. The method of claim 16, wherein the step of selecting comprises the step of comparing a possible error in position (EPE) reported by a first SPS receiver with a possible error in position reported by at least second SPS receiver and selecting the measurement with the least amount of EPE for the predetermined application.

18. The method of claim 16, wherein the step of selecting comprises the step of selecting among calculated measurements from each of the plurality of co-located SPS receivers based on a higher average signal strength from the plurality of SPS satellites and a larger number of SPS satellites used in a positioning calculation.

19. The method of claim 16, wherein the step of selecting comprises the step of selecting among calculated measurements from each of the plurality of co-located SPS receivers based on a desired navigation performance or a desired acquisition performance.

20. The method of claim 16, wherein the method further comprises the step of sharing ephemeris data or almanac data from a first reporting SPS receiver among the plurality of SPS receivers with at least a second SPS receiver.
